(19) United States
(12) Patent Application Publication
(10) Pub. No.: US 2011/0173026 A1
(43) Pub. Date: Jul. 14, 2011

(54) Medication Therapy Review Methods

(76) Inventors: Samuel W. Bartholomew, III, Nashville, TN (US); Michael D. Hogue, Mt. Olive, AL (US); Scott A. McDaniel, Murfreesboro, TN (US); Bradley P. Tice, Franklin, TN (US)

(21) Appl. No.: 13/073,610

(22) Filed: Mar. 28, 2011

Related U.S. Application Data
(63) Continuation of application No. 12/328,996, filed on Dec. 5, 2008, now abandoned.
(60) Provisional application No. 61/005,467, filed on Dec. 5, 2007.

(51) Int. Cl. G06Q 50/00; G06Q 10/00

(52) U.S. Cl. 705/2

(57) ABSTRACT

A method for population and patient-specific medication therapy review using a computer particularly adapted for a medication therapy management or health care delivery organization is provided, wherein the method includes at least the steps of: collecting patient claims data; reviewing the patient claims data for accuracy and data integrity; identifying particular characteristics sought within the patient claims data; organizing and structuring the patient claims data; establishing a set of clinical rules; transforming the set of clinical rules established into a computer language, and entering the transformed clinical rules into an electronic database; and analyzing the patient claims data by applying the clinical rules using a computer particularly adapted for a medication therapy management or health care delivery organization, thereby producing an analytical result. In further embodiments, the analytic results are used to evaluate the need for patient-level medication therapy review and, optionally, to actually conduct a patient-level medication therapy review based on the review of the analytic results.

### CROSS-REFERENCE TO RELATED APPLICATIONS

The present application is a continuation of U.S. Non-Provisional application Ser. No. 12/328,996 filed Dec. 5, 2008, still pending, which claims the benefit of prior U.S. provisional application No. 61/005,467 filed Dec. 5, 2007.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to a computer implemented system or method particularly adapted for a medication therapy management or health care delivery organization, and more particularly wherein the system or method processes population and individual records of diagnosis, diagnostic procedures, medical, and/or medication treatment of a patient.

2. Description of Related Art

Under the Medicare Modernization Act of 2003, a medication therapy management program (MTM) is a program of drug therapy management that may be furnished by a pharmacist and that is designed to assure targeted beneficiaries that covered Medicare part D drugs under a prescription drug plan are appropriately used to optimize therapeutic outcomes through improved medication use, and to reduce the risk of adverse events, including adverse drug interactions (42 U.S.C. §1395w-104(c)). Under the statute, individuals targeted by MTM programs are those who 1) have multiple chronic diseases (e.g., diabetes, asthma, hypertension, hyperlipidemia, and congestive heart failure), 2) are taking multiple drugs covered under Medicare part D, and 3) are identified as likely to incur annual costs for covered part D drugs that exceed a specified level.

Although Congress mandated the provision of MTM services only to such recipients, eleven national pharmacy organizations have agreed upon a more expansive definition of MTM as a set of services provided by pharmacists or other qualified health care providers. Such services may include: performing or obtaining assessments of patient health status; formulating a medication treatment plan; selecting, initiating, modifying and/or administering medication therapy; monitoring and evaluating patient response to therapy, including safety and efficacy; performing a comprehensive medication review to identify, resolve, and prevent medication related problems, including adverse drug events; documenting the care delivered and communicating essential information to a patient's primary care providers; providing verbal education and training designed to enhance patient understanding and appropriate use of medications; providing information, support services, and resources designed to enhance patient compliance with therapeutic regimens; and coordinating and integrating MTM services within the broader health care management services provided to patients.

Because of its wide-reaching scope, the MTM service model represents an improvement over pharmacy benefit management systems, which focus principally on drug-based issues, and disease management systems, which focus principally on a patient's disease.

Pharmacy benefit management companies (PBMs) currently use software programs to identify certain drug-related problems. Examples of such companies include Caremark, Medco, and Pharmacare. Because PBMs manage only pharmacy claims, though, the drug-related problems identified are restricted to problems which are “drug only.” In other words, PBMs identify only high dosages, low dosages, drug-to-drug interactions, non-formulary drugs, early refills, late refills, therapeutic duplication (two dispensed drugs performing essentially the same function in the body), drug-gender interactions, and drug and dosage checks based upon age. When PBMs identify such problems, an electronic message is transmitted to the dispensing pharmacy at the time of claim submission to alert the pharmacist of the potential problem. In addition, many PBMs also send letters and/or faxes, and occasionally place telephone calls to prescribers to alert them of the potential problem. There is no guarantee, however, that these pharmacy or prescriber alerts are acted upon, and there is no consistent mechanism in place to ensure that the problem is actually resolved.

Disease management companies (DMs) partner with individual patients through their employer or health plan to provide disease-specific health and wellness education, and training. Examples of such companies include Healthways, Health Management Corporation, and Matria. The most common diseases for which DMs provide service are diabetes, asthma, smoking cessation, hypertension, multiple sclerosis, and hepatitis C. With regard to drugs, drug-related problems, and acute diseases, however, DMs do not provide consistent programs for identifying or resolving drug-related problems because their drug-related services are focused principally on ensuring that directions for use are reinforced and compliance with therapy is maintained

To address the shortcomings of PBMs and DMs, a few companies have developed methods of providing MTM services, but the services provided and the methods by which they are provided are distinct from those of the present invention. For example, Community MTM Services, Inc. (Community MTM) is a provider of MTM services and a subsidiary of the National Community Pharmacists Association (NCPA). Community MTM contracts with PBMs and employers to provide MTM services through the NCPA's network of independent community pharmacies (approximately 24,000 across the United States). Community MTM uses documentation software that allows collection of data in a common format for the purposes of reporting back to their clients and for determining compensation to their network. The company also utilizes basic Medicare-dictated criteria to identify patients needing MTM services, and then provides this information to a local pharmacist who is willing to provide the service. Pharmacists then have an open window of time (typically several weeks) to contact the eligible patient, invite them to the pharmacy for a face-to-face MTM encounter, document the encounter using the documentation software, and transmit the information collected to Community MTM. Afterward, payment is sent to the pharmacy for providing the service. If the pharmacist determines that an identified patient is deceased and informs Community MTM of this fact, Community MTM will pay the pharmacy for assisting in updating their records via the documentation system. If the pharmacist does not act or provide service to the identified patients, then the patients continue to roll back onto the eligibility list period after period. However, Community MTM has no system in place to ensure that all eligible patients receive MTM services through their system. Additionally, Community MTM's system does not create a longitudinal patient care record. Pharmacists document the services they perform related to the billing event, but this does not build a patient record over time. The present invention, though, creates a longitudinal patient care record. Also, the Community MTM system is transaction-oriented and does not assist in follow-up with patients. The present invention ensures follow-up with patients through computerized technology applications. The Community MTM system relies entirely on face-to-face patient-pharmacist interactions for patient care and documentation. The system does not automate letter, phone, email, fax, and other technological communications with patients or providers to ensure the total care process is delivered. The present invention is a total care management solution for medication therapy management.

Another provider of MTM services is Outcomes Pharmaceutical Health Care (Outcomes), which uses a web-based documentation and billing system in conjunction with its network of pharmacists. Outcomes identifies eligible patients based upon the Medicare criteria of multiple chronic diseases, multiple drugs covered under Medicare part D being taken, and likelihood of incurring annual costs for covered part D drugs that exceed a specified level. Outcomes has two methods of providing MTM services to eligible patients: either Outcomes identifies eligible patients and notifies a willing pharmacist MTM provider; or a pharmacist MTM provider can use the web-based Outcomes benefit package to identify a needed patient intervention, provide the MTM service, and then bill Outcomes for the service. Similar to Community MTM's system, Outcomes' system is also transaction oriented. The pharmacist documents the event-focused care for a billing purpose, but an ongoing patient record is not created. The present invention creates a complete patient record and is centered on a care process, not a billing process. Outcomes' system does have a disease-specific module related to the care of patients with diabetes which instills a process for caring for patients with the disease, but it does not have follow-up communications methodology for interventions. The present invention ensures that all care provided for any disease state has a HIPAA compliant, comprehensive communication follow-up process with the patient, the provider, the pharmacist and any other party involved in the care of the patient.

A third MTM service provider is excelleRx, Inc., a subsidiary of Omnicare. ExcelleRx is focused primarily on managing medications for hospice, end-of-life, and frail elderly patients. ExcelleRx owns three call centers and employs pharmacists, nurses, and a variety of technical staff to interface primarily with nurses caring for hospice and frail elderly patients. The company has developed patented clinical documentation software applications using stepped-care approaches to decision making to ensure a consistent level of service is provided by all employees. ExcelleRx was the first company to enter the market with services related to medication management. A key aspect of their delivery system is that the services provided are focused on the caregiver (usually a nurse) and problem-oriented. The present invention focuses the intervention first upon the patient, and incorporates communication with the various providers of healthcare services (e.g. doctors, nurses, pharmacists) as appropriate. The excelleRx system does not offer the ability to meet face-to-face with a pharmacist for medication therapy management services. The present invention provides the opportunity for patients to meet face-to-face with a pharmacist for medication therapy management services.

### BRIEF SUMMARY OF THE INVENTION

The present invention addresses the aforementioned shortcomings of the prior art. In addition, the present invention provides for efficiencies in service delivery and quality integration and control which currently do not exist in any system. The present invention integrates quality measures (e.g. the National Committee for Quality Assurance's Healthcare Effectiveness Data & Information Set, or HEDIS, AHRQ's Quality Measures Clearinghouse™, etc.) and then further refines the measures according to evidence-based medical literature one to three levels deeper than existing published quality measures. The present invention allows for quality grading which exceeds minimum published quality measures. The present invention undergoes quality control review by medical and pharmacy experts to ensure the most current quality parameters are being met. In addition, the present invention incorporates action steps (“interventions”) based upon desired and proven outcome measures and create quality and consistency in service delivery. Unlike the prior art, the present invention does not rely on a single point for interventions based upon the medication therapy review but rather uses multiple intervention strategies with follow-up reinforcement. There is currently no similar invention which provides fully-automated, outcomes driven, comprehensive services using medication therapy reviews from multiple data sources as described previously.

In a method according to an embodiment of the present invention, pharmacy claims data for beneficiaries of a prescription drug benefit plan are obtained. Additional data regarding the beneficiaries is also obtained Examples of data obtained include pharmacy claims, medical claims (e.g., physician visits, hospital visits, etc.), beneficiary demographic and occupational data, clinical laboratory data, health risk assessment data, and medication risk assessment data. Depending on the data available, the data is then checked to ensure its accuracy and integrity. Characteristics of data sought are identified, and the data is then organized and structured according to those characteristics. A set of clinical rules is established, using such criteria and information as that published by the Agency for Healthcare Research and Quality (AHRQ, an arm of the U.S. Department of Health & Human Services), the American Medical Association (AMA), and other agencies and organizations generally recognized and accepted as creating and publishing quality measures in health care, as well as information available from evidence-based medical literature which may provide further guidance and/or improvements upon existing published quality measures. The clinical rules are transformed into computer language utilizing existing health care procedure coding terminology, such as the American Medical Association's Current Procedure Terminology (CPT) codes, the International Classification of Disease (ICD) codes, currently operational in its 9th and 10th versions as ICD-9 and ICD-10, respectively, National Drug Codes (published by the U.S. Food and Drug Administration), codes utilized by the Centers for Medicare and Medicaid Services (CMS) for medical procedures, services, supplies, and other items (the Healthcare Common Procedure Coding System, or HCPCS), and other codes unique to the drug database of the present invention, which identifies categories and classes of drugs.

At least some of the pharmacy claims data may be supplied by an interested third party (e.g., the beneficiaries' employer or insurer), and the analysis may be performed at the behest of the third party, whereupon the resulting set of recommendations is provided to the third party.

Furthermore, a formulary may be incorporated into the analysis step, whereby the recommendations output is customized so formulary items are recommended, where possible.

The data is stored in a relational database which is encrypted in situ. The data is kept indefinitely.

The data is not de-identified when entered into the system because the present invention involves a care process which is patient-specific and requires follow-up with specific patients to ensure appropriate drug therapy outcomes.

Through these methods, the present invention is able to ensure that nationally recognized treatment guidelines are integrated into health practice much more quickly than is currently seen. Estimates have the incorporation of treatment guidelines into provider practice taking between 5 to 17 years depending upon the area of health practice. The present invention integrates new guidelines and evidence in as little as a few days to a few months at most. This results in improved patient health and significant cost savings to the healthcare system, as well as improved employee productivity. In addition, the present invention vastly improves the care process for medication use. Prior to the present invention, identification of a narrow spectrum of medication-related problems was widely possible; however, the present invention is the first to provide a comprehensive, outcomes-based follow-through process to ensure that medication-related problems are not only identified, but resolved. This leads to significantly fewer medication-related hospitalizations, fewer medication-related adverse events requiring further treatments, fewer emergency department visits, fewer unnecessary visits to physician offices, fewer missed days from work, fewer medication-related deaths, and an improved quality of life for patients taking medications which are intended to be life-saving. The present invention solves existing medication-related problems and then continuously provides education and monitors the patient's medical and pharmacy care to ensure the patient does not develop any new medication-related problems. This invention is the first to provide prospective education and monitoring in this manner.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a flow diagram of a method for patient-specific medication therapy review.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

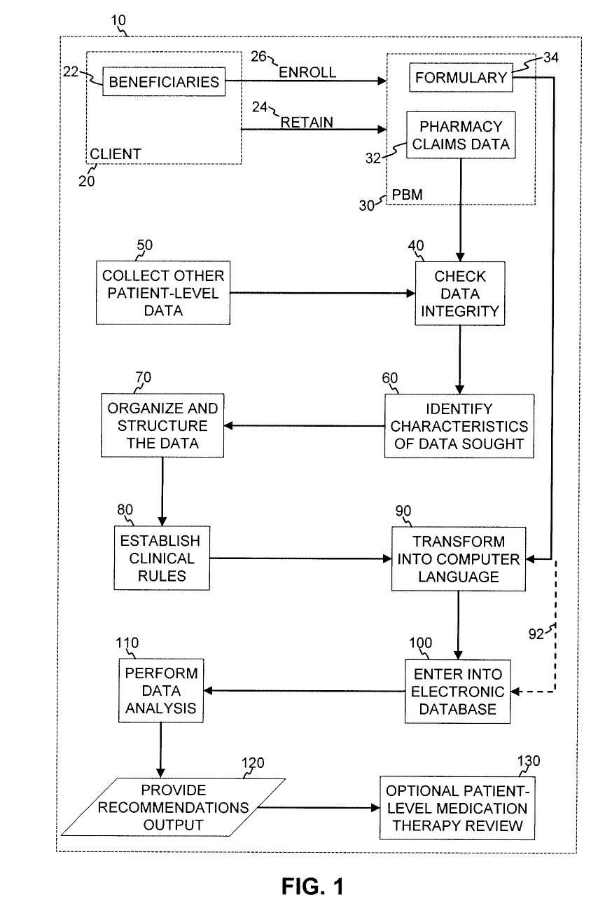

A flow diagram of a method for patient-specific medication therapy review is shown in FIG. 1. The review (10) may be initiated at the request of client (20), which provides healthcare benefits for its employees/beneficiaries (22) or which itself may be a health plan providing benefits on behalf of one or more employers. The client (20) provides healthcare benefits for its employees/beneficiaries (22) in part by retaining (24) pharmacy benefit management company (PBM) and/or health plan (30) to manage said benefits for enrolled (26) beneficiaries. PBM/health plan (30) as part of its/their regular services to client (20), collects claims data (32) comprising information on the pharmacy and/or medical claims of the client's beneficiaries. Examples of collected claims data (32) include patient-level data regarding diagnosis, medical procedures, medical encounters (i.e. hospitalization, physician office visit, emergency visit, etc.), medical equipment, and medication dispensing.

At step (40), claims data (32) from PBM/Health Plan (30) is checked for integrity. Examples of checking for data integrity include ensuring that patient-level data from multiple sources is matched correctly, ensuring that patient-level data is not duplicated, ensuring that all data requested has been provided, ensuring that data is complete and covers the timeframe for analysis, and ensuring the data is coded in such a way as to be compatible with the present invention/system. Other data, examples of which are laboratory result data, demographic and occupational data, health risk assessment data, and medication risk assessment data are also collected at step (50) and checked for integrity at step (40). At step (110) the population data is analyzed against a defined set of clinical rules based upon population level drug expenditures to determine if there are likely sufficient medication related problems in a population to proceed with patient-specific medication therapy review for the client. Population data is presented to the client in the aggregate (i.e. patient-specific information is de-identified so that employer is unaware of individual results) at step (120). If the analysis of population level data suggests the presence significant drug-related problems of sufficient possible economic impact, a patient-level medication therapy review may be conducted at step (130).

Data obtained from the data sources is not de-identified, as it is necessary for the patient-level medication therapy review for patient-specific demographic and contact information to be readily available to pharmacists and nurses performing clinic interventions identified as necessary during this review to ensure appropriate drug therapy outcomes. However, all staff has received appropriate HIPAA compliance training.

Aggregated patient level data (or “population level data”) is filtered through a set of clinical rules established at step (80). The clinical rules are complex and unique, and updateable and comprise the latest and best clinical knowledge, outcomes data, and national standards for drug therapy and disease treatment, quality standards, and economic indicators. Development of the clinical rules may also include: analysis of primary literature for evidence-based guidelines and recommendations appropriate for various disease states; product-specific manufacturer labeling; product recommendations from the Food and Drug Administration (FDA); drug information from tertiary sources; and economic factors, including availability of generic drugs. For example, a set of rules may be established to ensure patients with diabetes are receiving appropriate drug therapy. Such rules may include a review of the concomitant disease states the patient has present in his or her past medical history, results of pertinent laboratory findings, a review of past and current medication use, a review of the patient's demographic and family history, and a review of the patient's medication risk assessment. In one such example of a category/method, beneficiaries who have diabetes and hypertension, appropriate renal function, no history of drug allergies, and no history of use of a class of drugs indicated for first line use in this patient, with additional presence of a strong family history of diabetes and a medication risk assessment indicating the likelihood of avoidance of the health system, may be categorized as high risk.

The clinical rules are reviewed and updated A) upon the publication of new guidelines in the clinical area of concern, B) upon the publication of landmark evidence-based medical literature in the clinical area of concern, C) upon the notification of changes to drug use recommendations from either the manufacturer, the U.S. Food and Drug Administration, or other governmental agency, ID) the introduction of new treatment options in the clinical area of concern, or E) annually if none of the prior criteria are met.

The clinical rules of step (80) are transformed into computer language at step (90) and entered into an electronic database at step (100). In addition, formulary data (34) of PBM (30) may also be transformed into computer language at step (90). Alternatively, if formulary data (34) is provided by PBM (30) in a computer readable format, it may be entered directly into an electronic database at step (100), bypassing step (90), as shown by the dashed arrow (92).

An electronic database, such as that of step (100), provides a common site for merger and storage of large quantities of data from many computer operating systems such as, for example, UNIX, Linux, Microsoft MS-DOS, Windows NT, Windows 2000, Windows XP, Windows Vista, IBM OS/2, the Apple Macintosh Operating System, DEC VMS, and the like, facilitating integrated and informative analyses of said data based on logical queries.

At step (110), an analysis of the organized and structured data from step (70) is performed using the rules established at step (80) and transformed into computer readable format at step (90). The analysis at step (110) may indicate the presence of significant drug-related problems of sufficient possible economic impact such that a patient-level medication therapy review is optionally conducted at step (130).

At step (120), the results of the analysis are provided as a set of recommendations for consideration by the client. The recommendations may include pursuing a patient-level intervention process. The addition of formulary data (34) at steps (90) or (100) allows the analysis of step (110) to be customized, if desired, so that recommendations output of step (120) are formulary-compliant (i.e., recommended medications are contained within the formulary).

Numerous steps of the present invention involve the gathering, input, analysis, and output of data. One skilled in the art will recognize that such steps may be accomplished at one or more locations, with the data being transferred between locations as required to accomplish the various steps. For example, data may be transferred by telephone, facsimile, Ethernet, the Internet, mail, and courier. Preferably, the transfer of data is accomplished via an electronic communications network, such as an intranet or the Internet. This is dependent upon the technologic capabilities and data integrity of the parties from which the data is being collected.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A method for population and patient-specific medication therapy review using a computer particularly adapted for a medication therapy management or health care delivery organization, wherein the method comprises the following steps:
a) collecting patient claims data;
b) reviewing the patient claims data for accuracy and data integrity;
c) identifying characteristics sought within said patient claims data;
d) organizing and structuring the patient claims data;
e) establishing a set of clinical rules;
f) transforming the set of clinical rules established into a computer language, and entering the transformed clinical rules into an electronic database; and
g) analyzing the patient claims data by applying the clinical rules using a computer particularly adapted for a medication therapy management or health care delivery organization, thereby producing an analytical result.

2. The method of claim 1, further comprising:
transforming predetermined formulary data into a computer language; and entering the transformed data into an electronic database.

3. The method claim 1, further comprising:
collecting other patient data and combining it with the claims patient data of step a), thereby creating population-level data.

4. The method of claim 3, further comprising:
reviewing the population-level data for accuracy and data integrity;
identifying characteristics sought within said population-level data;
organizing and structuring the population-level data;
establishing a set of clinical rules;
transforming the set of clinical rules established into a computer language, and entering the transformed clinical rules into an electronic database;
analyzing the population-level data by applying the clinical rules using a computer particularly adapted for a medication therapy management or health care delivery organization, thereby producing an analytical result.

5. The method of claim 1, further comprising:
reviewing the analytic result of the patient claims data analysis to evaluate the need for patient-level medication therapy review.

6. The method of claim 5, further comprising:
optionally conducting a patient-level medication therapy review based on the review of said analytic results.

7. The method of claim 4, further comprising:
reviewing the analytic result of the population-level data analysis to evaluate the need for patient-level medication therapy review.

8. The method of claim 7, further comprising:
optionally conducting a patient-level medication therapy review based on the review of said analytic results.
